(19) United States
(12) Patent Application Publication
(10) Pub. No.: US 2025/0361331 A1
(43) Pub. Date: Nov. 27, 2025

(54) METHOD FOR PREPARING DOUBLE-LAYER SELF-CROSSLINKED ACRYLIC EMULSION

(71) Applicant: ZHENGZHOU UNIVERSITY, Zhengzhou City (CN)

(72) Inventors: Xianglin CHENG, Zhengzhou City (CN); Zeqi ZHOU, Zhengzhou City (CN); Ziyi QI, Zhengzhou City (CN)

(21) Appl. No.: 19/071,947

(22) Filed: Mar. 6, 2025

(30) Foreign Application Priority Data
May 24, 2024 (CN) 202410653538.6

(51) Int. Cl. C08F 2/24; C08F 220/18; C08F 220/56; C08F 257/02; C08J 3/24

(52) U.S. Cl. CPC C08F 2/24; C08F 220/1804; C08F 220/56; C08F 257/02; C08J 3/24; C08J 2333/12

(57) ABSTRACT

Provided is a method for preparing a double-layer self-crosslinked acrylic emulsion, including: conducting preparation of an emulsion, preparation of pre-emulsifier solutions, preparation of pre-emulsions, core-layer polymerization, and shell-layer polymerization in sequence to obtain a core-shell acrylic emulsion.

### CROSS REFERENCE TO RELATED APPLICATION

This patent application claims the benefit and priority of Chinese Patent Application No. 202410653538.6 filed with the China National Intellectual Property Administration on May 24, 2024, the disclosure of which is incorporated by reference herein in its entirety as part of the present application.

### TECHNICAL FIELD

The present disclosure belongs to the technical field of polymeric materials, and in particular relates to a method for preparing a double-layer self-crosslinked acrylic emulsion.

### BACKGROUND

Conventional solvent-based inks are gradually being phased out of the market due to the presence of volatile organic compounds (VOCs) and significant safety hazards. An environmentally friendly water-based ink is basically free of VOCs, becoming a new direction for the development of the ink industry. However, the environmentally friendly water-based ink also has disadvantages such as poor water resistance, poor solvent resistance, and “hot stickiness and cold brittleness”. Therefore, it needs to be modified to prepare new high-performance and environmentally friendly water-based inks.

The problems above are mainly relieved by synthesizing new acrylic emulsions through functional monomer modification or molecular design. Emulsions with a self-crosslinked core-shell structure prepared by molecular design can improve the hardness and heat resistance of the coating. Diacetone acrylamide (DAAM) is often used as a modifying monomer because of its ability to self-crosslink at room temperature. However, the water resistance of the modified acrylate emulsion as a hydrophilic monomer still needs to be improved, and new emulsion synthesis methods need to be developed.

Conventional emulsion polymerization mostly uses a thermal initiator as the initiation system, which requires high reaction temperature, has poor system stability, is prone to produce gel, and has a risk of explosive polymerization. A redox initiation system can spontaneously produce free radicals required for the polymerization reaction, which greatly reduces the activation energy of the reaction system and allows the reaction to be carried out at a lower temperature, thereby improving the overall stability of the system. However, there are few research reports on such redox systems. It is one of the research directions of the emulsion synthesis process to develop a lower-temperature initiation system, reduce the gel produced in the production process, stabilize the reaction process, and improve the economy of the emulsion synthesis process.

### SUMMARY

An object of the present disclosure is to provide a method for preparing a double-layer self-crosslinked acrylic emulsion. The prepared emulsion shows excellent water resistance, solvent resistance, and heat resistance.

The present disclosure provides the following technical solutions:

The present disclosure provides a method for preparing a double-layer self-crosslinked acrylic emulsion, including the following steps:

S1, adding an emulsifier and a pH buffer to a four-neck flask equipped with an electric stirrer, a thermometer, a condenser, and a dropping funnel, and subjecting a resulting mixture to heating in a water bath while stirring to dissolve the emulsifier to obtain the emulsion;

S2, mixing the emulsifier with deionized water, and dissolving the emulsifier to obtain a compounded emulsifier solution, and dividing the compounded emulsifie solution into two parts according to a mass ratio to obtain a core pre-emulsifier solution and a shell pre-emulsifier solution;

S3, dropwise adding acrylic monomers for core and an organosilicon monomer vinyltrimethoxysilane as a crosslinking agent to the core pre-emulsifier solution obtained in S2 to obtain a core pre-emulsion; and

dropwise adding acrylic monomers for shell and diacetone acrylamide to the shell pre-emulsifier solution obtained in S2 to obtain a shell pre-emulsion;

S4, adding 1/10 by mass of the core pre-emulsion obtained in S3 to the emulsion in the four-neck flask in S1, heating a resulting mixed material in the water bath, and adding ⅓ by mass of an initiator to initiate a polymerization reaction, and under a condition that a resulting solution in the four-neck flask has a blue tinge, conducting the polymerization reaction for a period time, then adjusting reaction conditions, and dropwise addeding a remaining core pre-emulsion and ⅖ by mass of a remaining initiator to the four-neck flask to obtain a core-layer emulsion.

S5, dropwise addeding the shell pre-emulsion obtained in S3 and a resulting remaining initiator after S4 to the core-layer emulsion in S4, and conducting a reaction by heating in the water bath; and after completing the reaction, stopping the heating in the water bath, naturally cooling a resulting system and adjusting a pH of the resulting system to 8 to 9, and then adding 0. 1% to 5% by mass of adipic acid dihydrazide, and stirring a resulting substance at a rotation speed of 100 r/min to 800 r/min for 30 min, and filtrating the resulting substance with a 100-mesh metal screen to obtain a core-shell acrylic emulsion.

In some embodiments, in S1, the heating in the water bath is conducted at a temperature of 30° C. to 50° C. and the stirring is conducted at a speed of 150 r/min.

In some embodiments, in S2, the compounded emulsifier solution is divided into two parts according to the mass ratio of 1-3:1-4.

In some embodiments, in S3, the acrylic monomers for the core include 1% to 30% by mass of styrene, 1% to 35% by mass of butyl acrylate, and a remainder being methyl methacrylate; and

the acrylic monomers for the shell include 1% to 50% by mass of methyl methacrylate, 1% to 45% by mass of butyl acrylate, and the a remainder being styrene.

In some embodiments, in S4, the 1/10 by mass of the core pre-emulsion is added to the four-neck flask in S1 and a resulting mixed material is heated to 60° C. to 90° C. in the water bath.

In some embodiments, in S4, under the condition that the resulting solution in the four-neck flask has the blue tinge, the polymerization reaction is conducted for 10 min to 60 min, then a rotation speed in the reaction conditions is adjusted to 100 r/min to 800 r/min, and a temperature for the water bath is adjusted to 60° C. to 90° C.

In some embodiments, in S4, the remaining core pre-emulsion and the ⅖ by mass of the remaining initiator are added dropwise to the four-neck flask within 0.5 h to 2 h and a resulting mixture is then held for 0.5 h to 3.5 h.

In some embodiments, in S5, the shell pre-emulsion and the resulting remaining initiator afer S4 are added dropwise to the four-neck flask in S4 within 0.5 h to 2 h and a resulting mixture is then held for 0.5 h to 3.5 h.

In some embodiments, the emulsifier is a mixture of (1-allyloxy-3-(4-nonylphenol)-2-propanol polyoxyethylene (10) ether sulfate and alkylphenol polyoxyethylene ether in a mixing ratio of 0. 1-6:1, the pH buffer is an AMP-95 solution, and the initiator is at least one selected from the group consisting of potassium persulfate ammonium persulfate, and sodium bisulfite.

The present disclosure further provides use of the double-layer self-crosslinked acrylic emulsion in preparation of a binder for water-soluble inks.

Compared with the prior art, some embodiments of the present disclosure have the following beneficial effects:

(1) In the present disclosure, a double-layer self-crosslinked acrylate core-shell emulsion is synthesized. During film formation, both the core and shell layers are crosslinked, such that the water resistance, solvent resistance, and heat resistance of the emulsion are improved, and the problem of hot sticking and cold brittleness of the acrylic emulsion used for conventional water-soluble inks is solved.

(2) A redox initiator is used as the initiation system, and the semicontinuous seeded emulsion polymerization is used to synthesize the emulsion. The redox initiation system can spontaneously produce free radicals required for the polymerization reaction, which greatly reduces the activation energy of the reaction system and allows the reaction to be carried out at a lower temperature, thereby improving the overall stability of the system.

### DETAILED DESCRIPTION OF THE EMBODIMENTS

The technical solution of the present disclosure is further explained below by way of examples.

Unless defined otherwise, the technical or scientific terms used in the present disclosure should have the common meanings as understood by those skilled in the art to which the present disclosure belongs.

### EXAMPLE 1

In Example 1, a method for preparing a double-layer self-crosslinked acrylate core-shell emulsion was performed as follows:

S1, preparation of an emulsion: 6 g of a mixture of (1-allyloxy-3-(4-nonylphenol)-2-propanol polyoxyethylene (10) ether sulfate and alkylphenol polyoxyethylene ether in a mixing ratio of 1:1, and 1 mL of an AMP-95 solution as a pH buffer were added to a four-neck flask equipped with an electric stirrer, a thermometer, a condenser and a dropping funnel, and a resulting mixture was heated in a water bath at 40° C. while stirring at a speed of 150 r/min to fully dissolve the emulsifier to obtain the emulsion.

S2, preparation of pre-emulsifier solutions: 9 g of the mixture of (1-allyloxy-3-(4-nonylphenol)-2-propanol polyoxyethylene (10) ether sulfate and alkylphenol polyoxyethylene ether in the mixing ratio of 1:1 was mixed with 500 mL of deionized water and the mixture was fully dissolved. A resulting solution was divided into two parts according to a mass ratio of 1:1 to obtain a core pre-emulsifier solution and a shell pre-emulsifier solution.

S3, preparation of pre-emulsions: 200 g of acrylic monomers for core (consisting of 20 g of styrene, 110 g of methyl methacrylate, and 70 g of butyl acrylate) and 6 g of an organosilicon monomer vinyltrimethoxysilane as a crosslinking agent were slowly added dropwise to the core pre-emulsifier solution obtained in S2 to obtain a core pre-emulsion.

300 g of acrylic monomers for shell (consisting of 120 g of methyl methacrylate, 120 g of butyl acrylate, and 60 g of styrene) and 6 g of diacetone acrylamide were slowly added dropwise to the shell pre-emulsifier solution obtained in S2 to obtain a shell pre-emulsion.

S4, core-layer polymerization: 1/10 by mass of the core pre-emulsion obtained in S3 was added to the emulsion in the four-neck flask in S1 and a resulting mixture was heated in the water bath to 70° C. ⅓ by mass of potassium persulfate (a total amount of an initiator was 2 g) was added to initiate a polymerization reaction. Under a condition that a resulting solution in the four-neck flask had a faint blue tinge, the polymerization reaction was conducted for 30 min, then a rotation speed was adjusted to 300 r/min, and a temperature for the water bath was adjusted to 72° C. A remaining core pre-emulsion and ⅖ by mass of a remaining potassium persulfate were slowly added dropwise to the four-neck flask at a constant speed within 1 h, and a resulting mixture was held for 1.5 h to obtain a core-layer emulsion.

S5, shell-layer polymerization: the shell pre-emulsion obtained in S3 and a resulting remaining initiator after S4 were slowly added dropwise to the core-layer emulsion in S4 at a constant speed within 1.5 h, and a resulting mixture was held for 1 h, and a reaction was conducted by heating in the water bath. After the reaction was completed, the heating in the water bath was stopped, a resulting system was naturally cooled and adjusted to pH 8.5. Then 5% of adipic acid dihydrazide was added and stirred at a constant rotation speed of 100 r/min for 30 min. Then a resulting mixture was filtrated with a 100-mesh metal screen to obtain a core-shell acrylic emulsion.

### COMPARATIVE EXAMPLE 1

In this example, a method for preparing an acrylate emulsion was performed as follows:

S1, preparation of pre-emulsion: 6 g of emulsifiers consisting of a DNS-86 emulsifier and a LCN-287 emulsifier and deionized water were weighed accurately in a conical flask. The conical flask was placed on a magnetic stirrer and stirred until the emulsifiers were completely dissolved. After dissolution, a stirring rotation speed was increased, 200 g of a mixture of all monomers (MMA, BA, and NMA) that had been weighed in advance was slowly added thereto at a constant speed with stirring. The stirring was conducted for another 30 min to obtain a milk-like, homogeneous, and stable pre-emulsion.

S2, preparation of initiator solution: 0.667 g of an initiator of potassium persulfate was weighed and fully dissolved in deionized water for later use.

S3, preparation of an emulsion: In a four-neck flask equipped with an electric stirrer, a thermometer, a reflux condenser, and a constant flow pump feed tube, a certain amount of deionized water, a certain amount of an emulsifier, and a buffer NaHCO, were added as a base. After stirring for a period of time until the above raw materials were dissolved, 10% of a total volume of the pre-emulsion was added thereto, a rotation speed was set to 200 rpm, a resulting system was heated to 78° C. and ⅓ of a total volume of a initiator APS solution was added to initiate a polymerization reaction, showing blue tinge. After the polymerization reaction was conducted for 30 min, a remaining pre-emulsion and initiator APS solution were added dropwise at a constant speed by using a constant flow pump and a reaction was conducted, and a temperature for the reaction was controlled to be stable, where the pre-emulsion was added dropwise within 2 h, then the initiator APS solution was added dropwise within 10 min. After addition, a resulting system was maintained at a original temperature for the reaction for 1 h and then heated to 83° C. for the reaction for 0. 5 h. After the reaction was finished, a resulting emulsion was naturally cooled to room temperature, neutralized with a pH regulator AMP-95 to pH 8.5, filtered with a 100-mesh nylon filter cloth, and discharged to obtain the acrylate emulsion with a solid content of 47%.

The acrylic emulsions prepared in Example 1 and Comparative example 1 were tested for relevant performance, such as water resistance, solvent resistance, and thermal stability, with reference to GB/T 1733-1993, GB/T 23989-2009 and other standards. The test results are as follows:

(1) Water resistance: after soaking for 72 hours according to GB/T 1733-1993, the coating of the core-shell acrylic emulsion prepared in Example 1 does not change, while the coating of the acrylate emulsion prepared in Comparative example 1 turns white.

(2) solvent resistance: after coating 50 times according to GB/T 23989-2009, the coating of the core-shell acrylic emulsion prepared in Example 1 does not change after rubbing, while the coating of the acrylate emulsion prepared in Comparative example 1 is dissolved during rubbing.

(3) Thermal stability: the thermal decomposition temperature of the coating of the core-shell acrylic emulsion prepared in Example 1 is 354° C., while the thermal decomposition temperature of the coating of the acrylate emulsion prepared in Comparative example 1 is 304° C.

From the above tests, it can be found that the core-shell acrylic emulsion provided in Example 1 of the present disclosure shows excellent water resistance, solvent resistance, and thermal stability.

The core-shell acrylic emulsion obtained in Example 1 above was used to prepare a binder for water-soluble inks. The binder for water-soluble inks was prepared by mixing the core-shell acrylic emulsion and a black paste in a mass ratio of 3:2, and adding a dispersant, a leveling agent, and an anti-foaming agent thereto.

The binder for water-soluble inks obtained above was subjected to a printing test on a gravure printing machine. The test results show that the binder exhibits excellent printing performance, strong adhesion, and bright color.

It should be finally noted that the examples above are merely intended to explain rather than limit the technical solutions of the present disclosure.

Although the present disclosure has been described in detail with reference to the preferred examples, those skilled in the art should understand that modifications or equivalent substitutions may still be made to the technical solutions of the present disclosure, while such modifications or equivalent substitutions should not cause the modified technical solutions to depart from the spirit and scope of the technical solutions of the present disclosure.

What is claimed is:

1. A method for preparing a double-layer self-crosslinked acrylic emulsion, comprising:
S1, adding an emulsifier and a pH buffer to a four-neck flask equipped with an electric stirrer, a thermometer, a condenser, and a dropping funnel, and subjecting a resulting mixture to heating in a water bath while stirring to dissolve the emulsifier to obtain the emulsion;
S2, mixing the emulsifier with deionized water and dissolving the emulsifier to obtain a compounded emulsifier solution, and dividing the compounded emulsifier solution into two parts according to a mass ratio to obtain a core pre-emulsifier solution and a shell pre-emulsifier solution;
S3, dropwise adding acrylic monomers for core and an organosilicon monomer vinyltrimethoxysilane as a crosslinking agent to the core pre-emulsifier solution obtained in S2 to obtain a core pre-emulsion; and
dropwise adding acrylic monomers for shell and diacetone acrylamide to the shell pre-emulsifier solution obtained in S2 to obtain a shell pre-emulsion;
S4, adding 1/10 (one-tenth) by mass of the core pre-emulsion obtained in S3 to the emulsion in the four-neck flask in S1, heating a resulting mixed material in the water bath, and adding ⅓ (one-third) by mass of an initiator to initiate a polymerization reaction, and under a condition that a resulting solution in the four-neck flask has a blue tinge, conducting the polymerization reaction for a period of time, then adjusting reaction conditions, and dropwise adding a remaining core pre-emulsion and ⅖ (two-fifths) by mass of a remaining initiator to the four-neck flask to obtain a core-layer emulsion; and
S5, dropwise adding the shell pre-emulsion obtained in S3 and a resulting remaining initiator after S4 to the core-layer emulsion obtained in S4, and conducting a reaction by heating in the water bath; and after completing the reaction, stopping the heating in the water bath, naturally cooling a resulting system and adjusting a pH of the resulting system to 8 to 9, then adding 0.1% to 5% by mass of adipic acid dihydrazide, stirring a resulting substance at a rotation speed of 100 r/min to 800 r/min for 30 minutes, and filtering the resulting substance with a 100-mesh metal screen to obtain a core-shell acrylic emulsion.

2. The method for preparing the double-layer self-crosslinked acrylic emulsion of claim 1, wherein in S1, the heating in the water bath is conducted at a temperature of 30° C. to 50° C., and the stirring is conducted at a speed of 150 r/min.

3. The method for preparing the double-layer self-crosslinked acrylic emulsion of claim 1, wherein in S2, the compounded emulsifier solution is divided into two parts according to the mass ratio of 1-3:1-4.

4. The method for preparing the double-layer self-crosslinked acrylic emulsion of claim 1, wherein in S3,
the acrylic monomers for the core comprise 1% to 30% by mass of styrene, 1% to 35% by mass of butyl acrylate, and a remainder being methyl methacrylate; and
the acrylic monomers for the shell comprise 1% to 50% by mass of methyl methacrylate, 1% to 45% by mass of butyl acrylate, and a remainder being styrene.

5. The method for preparing the double-layer self-crosslinked acrylic emulsion of claim 1, wherein in S4, the 1/10 by mass of the core pre-emulsion is added to the four-neck flask in S1, and the resulting mixed material is heated to 60° C. to 90° C. in the water bath.

6. The method for preparing the double-layer self-crosslinked acrylic emulsion of claim 1, wherein in S4, under the condition that the resulting solution in the four-neck flask has the blue tinge, the polymerization reaction is conducted for 10 minutes to 60 minutes, then a rotation speed in the reaction conditions is adjusted to 100 r/min to 800 r/min, and a temperature for the water bath is adjusted to 60° C. to 90° C.

7. The method for preparing the double-layer self-crosslinked acrylic emulsion of claim 1, wherein in S4, the remaining core pre-emulsion and the ⅖ by mass of the remaining initiator are added dropwise to the four-neck flask within 0.5 hours to 2 hours, and a resulting mixture is then held for 0.5 hours to 3.5 hours.

8. The method for preparing the double-layer self-crosslinked acrylic emulsion of claim 1, wherein in S5, the shell pre-emulsion and the resulting remaining initiator after S4 are added dropwise to the four-neck flask in S4 within 0. 5 hours to 2 hours, and a resulting mixture is then held for 0.5 hours to 3.5 hours.

9. The method for preparing the double-layer self-crosslinked acrylic emulsion of claim 1, wherein the emulsifier is a mixture of (1-allyloxy-3-(4-nonylphenol)-2-propanol polyoxyethylene (10) ether sulfate and alkylphenol polyoxyethylene ether in a mixing ratio of 0.1-6:1;
the pH buffer is an AMP-95 solution; and
the initiator is at least one selected from the group consisting of potassium persulfate, ammonium persulfate, and sodium bisulfite.

10. The method for preparing the double-layer self-crosslinked acrylic emulsion of claim 9, wherein in S1, the heating in the water bath is conducted at a temperature of 30° C. to 50° C., and the stirring is conducted at a speed of 150 r/min.

11. The method for preparing the double-layer self-crosslinked acrylic emulsion of claim 9, wherein in S2, the compounded emulsifier solution is divided into two parts according to the mass ratio of 1-3:1-4.

12. The method for preparing the double-layer self-crosslinked acrylic emulsion of claim 9, wherein in S3,
the acrylic monomers for the core comprise 1% to 30% by mass of styrene, 1% to 35% by mass of butyl acrylate, and a remainder being methyl methacrylate; and
the acrylic monomers for the shell comprise 1% to 50% by mass of methyl methacrylate, 1% to 45% by mass of butyl acrylate, and a remainder being styrene.

13. The method for preparing the double-layer self-crosslinked acrylic emulsion of claim 9, wherein in S4, the 1/10 by mass of the core pre-emulsion is added to the four-neck flask in S1, and the resulting mixed material is heated to 60° C. to 90° C. in the water bath.

14. The method for preparing the double-layer self-crosslinked acrylic emulsion of claim 9, wherein in S4, the remaining core pre-emulsion and the ⅖ by mass of the remaining initiator are added dropwise to the four-neck flask within 0.5 hours to 2 hours, and a resulting mixture is then held for 0.5 hours to 3.5 hours.

15. The method for preparing the double-layer self-crosslinked acrylic emulsion of claim 9, wherein in S5, the shell pre-emulsion and the resulting remaining initiator after S4 are added dropwise to the four-neck flask in S4 within 0.5 hours to 2 hours, and a resulting mixture is then held for 0.5 hours to 3.5 hours.
